(19) United States
(12) Patent Application Publication
(10) Pub. No.: US 2025/0187197 A1
(43) Pub. Date: Jun. 12, 2025

(54) REMOTE CONTROL OF ROBOTIC SYSTEMS AND UNITS

(71) Applicant: Grant Stegelmann, New York, NY (US)

(72) Inventor: Grant Stegelmann, New York, NY (US)

(21) Appl. No.: 19/056,211

(22) Filed: Feb. 18, 2025

Related U.S. Application Data
(63) Continuation of application No. PCT/US2023/030501, filed on Aug. 17, 2023.
(60) Provisional application No. 63/399,308, filed on Aug. 19, 2022.

(51) Int. Cl. B25J 9/16; G06Q 10/0631

(52) U.S. Cl. CPC B25J 9/1689; B25J 9/163; B25J 9/1674; G06Q 10/063112

(57) ABSTRACT

A method is provided for controlling a robotic unit, the method including operating the robotic unit to autonomously perform at least one task, identifying a portion of the task to be manually executed or supervised, and selecting an offsite target handler for manually executing or supervising the portion of the task. A request is then sent to the target handler selected. Upon receiving an indication of acceptance from the target handler, the method provides a remote control interface by which the portion of the task may be manually executed or supervised. The method may then receive, at the remote control interface, control inputs for the robotic unit. The method may then provide an information feed including real time status information for the robotic unit. The method may then confirm that the portion of the task has been completed and terminate the remote control interface.

### CROSS REFERENCE TO RELATED APPLICATIONS

This application is a continuation of International Patent Application No. PCT/US2023/030501, filed Aug. 17, 2023, which takes priority from U.S. Provisional Application No. 63/399,308, filed Aug. 19, 2022, the contents of which are incorporated by reference herein.

### FIELD OF THE INVENTION

The invention relates to the field of robotic controls, namely the use of a remote control system to control and/or monitor robotic systems in support of a generally autonomous process. This invention further relates to a human-machine interface (HMI) to visualize, implement, monitor, control, and manipulate robots remotely.

### BACKGROUND

In the process of playing video games, hobbyists develop skills and dexterities with handheld controllers. These skills enable the hobbyist to achieve missions and goals (i.e., actuate target outcomes) in a game's audio-visual loop. The development of such skills has become so popular and widespread that it is now competitive and formalized vis-à-vis eSports. These skills are a vast and underappreciated resource with considerable latent value to potential employers. This disclosure develops a remote control system whereby individuals with such skills can leverage their dexterities over a controller to actuate a real-life target outcome for productive tasks. A prime example is the implementation of modern collaborative robots (“cobots”).

Cobots became a major commercial success over the past decade because they are: (1) easy to understand, use, and implement, even for an untrained user, (2) inexpensive (often ˜$10-30 k), and (3) able to operate safely alongside human workers, e.g., without the need for safety cages. The value proposition of cobots is already evident through their widespread adoption and the proliferation of cobot manufacturers. However, remote controls are not a standard feature of cobots. Their current value proposition could be multiplied by the addition of such a fourth key characteristic: the ability to control them remotely using an interface that is similarly intuitive to their standard, in-person controls.

Traditional industrial robots were developed and commercialized starting in the 1950s by companies like FANUC of Japan. Those companies found success selling large, capable industrial robots, especially with automotive customers. However, these initial industrial robots were expensive, operated only in safety cages, and required trained programmers for their implementation, operation, and maintenance. As a result, they did not find much success outside of large-scale, well-capitalized manufacturers such as the major automotive OEMs.

In the 2010s, a new type of industrial robot was developed and commercialized: the collaborative robot or “cobot.” Relative to their traditional counterparts, cobots are a fraction of the cost, much smaller (i.e., only a simple, single arm), safe to operate collaboratively alongside workers, and can be implemented by a layperson with minimal training. Because of these key characteristics, cobots have been widely adopted by new groups of customers. Small and medium-sized businesses, which represent the majority of global manufacturing, are now able to experiment with robotics in their operations, without having to make large, risky bets on the expensive and complex traditional systems. The value proposition is also evident by the fact that new robotics OEMs are entering into the space.

Despite the commercial success of cobots so far, they have various problems, limitations, and opportunities for improvement. First, they cannot be controlled remotely. This manifests itself as a problem in several ways. Second, the different brands of cobots are nominally different, making it difficult for an operator to excel across all of them. Third, the current iteration of cobots does not change sufficiently the nature of manufacturing to attract younger demographics into a profession with an aging workforce. The systems and methods discussed herein may be utilized to address these problems.

The first problem with cobots that may be addressed in this disclosure is their inability to be controlled remotely. Robotics OEMs often explicitly state that remote control via TCP/IP is only for advanced users, and such remote control typically requires programming skills. Such programming skills are in addition to or in place of skills associated with controlling the robot or performing the underlying tasks the robots are being used for and would make it difficult to find candidates to control the cobots were a remote control system to be implemented.

Certain cobot manufacturers provide programs that allow for a modest amount of remote control. However, such user interfaces tend to be overly technical, lack usable feedback loops, such as an audio-visual loop, and are manufacturer specific, thereby providing limited industrial utility.

Part of the reason that manufacturers only recently started supporting remote controls is that they have purposefully adopted an “open platform” strategy, in which third parties are encouraged to design, develop and sell hardware and software for the platform. Open platform strategies like this allow for a faster pace of innovation than a robotics OEM would be able to achieve through their own internal R&D capabilities. Such strategies also help broaden the addressable market as third parties spend R&D dollars to fund new applications. Regardless of the reasoning, problems related to a lack of intuitive remote controls, and a lack of incentive to create intuitive controls, manifest themselves in productive settings in several ways.

One is with respect to the inability to correct real-time operating errors that occur with unmanned cobots expected to operate in a “lights-out” manufacturing environment. For example, a cobot may malfunction at 5:05 pm Friday afternoon, right after the last shift of a small manufacturer leaves for the weekend. The breakdown of the cobot may cause a substantial amount of production to be held up (perhaps $10,000, as an example) until the cobot error is corrected in-person by an employee of the next shift Monday morning at 9:00 am. With the systems and methods disclosed herein, a manufacturer would not have to wait until Monday to fix the operating error of the robot. Instead, an employee or platform member could remote in briefly to fix the error. They could presumably be paid a generous overtime rate for a few minutes to make the correction (perhaps $250). The difference between the benefit and cost in this scenario—$9,750—represents the profit unlocked by the system and method, to be split between employee, manufacturer, and owner of this system.

This first problem also manifests itself through the suboptimal pairing of capital and labor resources. Because cobots are designed to be operated in-person, the only labor available to operate them is the employees physically present inside of a given organization. However, there may be independent contractors who are not employees of the company that could also operate those same cobots. They may be willing to perform the necessary operations under the right circumstances and also may be able to do so more effectively than the in-person employee(s). The relative efficiency of an operator, whether employee or contractor, could be determined by their relevant experience, familiarity with a given type of robot/task/business, fluency in the language of the organization, or the times during which they are available. With remote controls, those independent contractors could be “remoted in” and paired optimally with a given cobot and associated task. Over time, if and as cobot operations are performed remotely, operators' experience levels will build within the context of the system of remote controls. Such accumulated historical performance could be used to improve the criteria by which labor is paired capital.

Another way in which the first problem manifests itself is through the lens of system integrators. System integrators are a critical group of individuals and businesses when it comes to industrial automation. Integrators often get involved with projects as early as the initial stages of conceptualization, all the way through vendor selection, initial implementation, ongoing system maintenance, upgrades, and later projects at the client. Integrators primarily compete on the basis of price, quality (e.g., accumulated project experience, referrals, track record), and timeline to completion. The timelines quoted by system integrators typically range from 6-12 months and assume the basic confines of implementing systems in-person. If a portion of the system implementation could be completed on a flexible, remote basis, the integrator may be able to shave off weeks or months from their quoted timeline, thereby positioning them to better win project mandates. The organization and/or its integrator may also be more comfortable beginning full-rate production operations with a cobot when it is only 80-90% integrated, knowing they will be able to remote in for ongoing error correction, as discussed earlier.

Last, the lack of remote controls manifests itself as a problem insofar as it limits the deployment of cobots in settings that are unsafe for in-person human control. For example, cobots cannot be deployed in locations with extreme temperatures, radiation, small access points, and hazards related to fire, explosives, or otherwise dangerous materials. With remote controls, cobots could be implemented and operated in such environments that pose threats to human workers' health or safety.

An additional problem this disclosure addresses is with regards to labor force participation in manufacturing. The labor force engaged in manufacturing is relatively old. As of 2020, 48.8% of the ˜14 million workers employed in manufacturing occupations were aged 45 and older. By comparison, only 44.2% of the ˜148 million workers in the overall labor force are 45 or more years old. The only other occupation with a labor force weighted more heavily to employees aged 45 and older is Public Administration, at 51.0%.

Younger workers gravitate to occupations in hospitality, retail, and services, not those in manufacturing. The demographic might be more attracted to pursue occupations in manufacturing if they were able to participate in the industry remotely through computers and video game systems. This is supported by the fact that of the ˜4 million employees engaged in “Computer systems design and related services” in the US, only 36.7% are aged 45 and older.

Manufacturers should find gamers particularly well equipped to operate cobots. In order to succeed in the context of a video game, users must provide sufficiently accurate inputs to a controller to actuate target outcomes, with a constant loop of audio and visual feedback. As a result, the gamer population is already primed to perform the types of remote cobot operating tasks contemplated by this disclosure. Gamers also represent a very large and growing population, with an estimated 2.8 billion active gamers worldwide in 2020, over one third of the world's population.

Gamers now compete as e-sport athletes, with many being paid to do so professionally. They compete and are paid on the basis of their ability to actuate target outcomes on a screen using their respective dexterities over a controller. eSports have exploded in popularity, growing from small events in hotel ballrooms to selling out large venues like Madison Square Garden. The huge growth in professional gaming, and its comparability to the system contemplated by this disclosure, makes the paid remote control of cobots seem like a simple logical progression, if not an overdue one.

An additional problem this disclosure addresses is manufacturers' limited ability to visualize, track, and manage tasks in an organized fashion. Today, workers in modern factories are assigned certain in-person tasks, and their performance of such tasks can increasingly be seen, monitored, and tracked with data from the machines they use to complete them. The more that labor can be visualized, the better an employer can recognize, incentivize, and reward efficient productivity. This ability would increase considerably if labor were converted into an entirely digital format, as would be necessary with the remote controls contemplated by this disclosure. The assignment, tracking, and completion of individual tasks and operations could be organized much better with the labor being digitized through a system of remote controls.

An additional problem this disclosure addresses for cobots is manufacturers' limited ability to convert labor into machine-automated processes, including applications of artificial intelligence. In recent years, prices of technology hardware and software have declined while their value propositions have increased. Much of the decline in technology pricing has been driven by cost-conscious consumers of products like TVs, phones, cameras, computers, wearables, home security systems, etc. The advancements and price deflation in consumer technologies are leverageable by producers and businesses. However, they are more challenging to implement. Anyone can appreciate the value proposition of a consumer technology, and how it will improve a user's life. A business may see the value of new technologies, but implementing it into operations creates risks and implementation costs. By reducing such risks and implementation costs, the system and method disclosed herein allows businesses to leverage the new wave of increasingly affordable hardware, software, and computing power.

In particular, manufacturers increasingly look for opportunities to implement applications of artificial intelligence and machine learning in their factories. Machine learning and artificial intelligence promise significant enhancements to productivity and reductions in labor cost. Manufacturers have unprecedent access to inexpensive computer power, learning software, and automation hardware. However, they are challenged in identifying specific opportunities for the application of these newly inexpensive technologies, let alone tracking, digitizing, and repeating them using a robot instead of a human worker. The systems and methods of this disclosure would help solve this problem given that a worker's remote control inputs will need to be converted into a digital format to be transmitted to a machine to function. These digitized control inputs could be analyzed by systems of machine learning in order to avoid the need for human input after a sufficient number of iterations. For example, a human operator may provide manual control inputs to actuate a robot towards a successful target outcome 10 times. Each time, the operator's inputs may vary slightly, as will the audio-visual feedback provided real-time to the operator. A machine learning program could compare the various iterations of operators' control inputs against the simultaneous audio-visual feedback and the target of the task. Perhaps on the 11th iteration, an AI program could attempt to perform the task autonomously without actual human input. In this context, the system and method contemplated here could be considered as a tool of automation system implementation—and feeding the AI machine—versus just a system of remote controls. The associated benefits from an increase in productivity and a reduction in labor costs will grow along with any applicable minimum wages, as are being contemplated on local, state, and federal levels.

An additional problem the system and method described herein may address is discrimination in the workplace. Prejudices and biases are not only morally reprehensible, but they also reduce productivity. This is the case whether the discrimination is conscious or not. Less qualified candidates for a job may be selected over more qualified ones due to age, race, skin color, gender, appearance, language, accent, perceived wealth, connections, or other inappropriate and irrelevant factors to actual job descriptions. Regardless of the cause, discrimination in the workplace persists. The systems and methods described herein would help alleviate the problem by making labor performance statistics more trackable and objective. Those statistics provide a more objective basis on which to hire and reward employees. Discrimination would be rooted out by productive necessity.

Various issues and considerations impede the development of intuitive, easy-to-use, standardized remote controls for cobots, like those contemplated by this disclosure. These issues include (i) communications latency between the operator and robot; (ii) rules and limitations implemented by video game platforms such as Xbox (Microsoft), Playstation (Sony) and Nintendo; (iii) opposition from the laborers whose jobs might be eliminated through automation; (iv) opposition from system integrators, whose business model may be disintermediated by remote implementation technologies; (v) opposition from manufacturers whose business model may be negatively impacted in the long-term by increased visibility into their operations; and (vi) privacy concerns, especially the recording and transmitting of sound and video from factory environments.

Latency causes problems for the remote control of robotics. In order for an operator to provide sufficiently correct inputs through a remote controller to actuate a robotic arm towards a target outcome, (s)he must have a feedback loop providing the current status of the said arm. Communication latency may cause an operator to actuate a robot beyond the state of the target outcome, because the feedback loop showed the real-life state of the robot with too long of a delay. Operators are thereby prone to overshooting a target outcome due to issues around latency. This has impeded the development of robotics remote controls in the past.

High-definition AV-feedback loops are data-intensive, and the systems and methods contemplated herein will require the communication to be very fast.

The development and approval process for video games (and even iPhone apps) is stringent and limiting in various ways. Microsoft-Xbox, Sony-Playstation, and Nintendo do not allow for custom modifications in how games run on their consoles. In particular, they do not allow for notifications beyond what their systems push to a user. They may tell a user when another player comes online, or that a software update is available for download. By comparison, a third party game is never allowed to provide notifications to users if the game is not running actively.

This inability to provide push notifications across video game applications creates a major roadblock for trying to develop a system as contemplated by this disclosure. Theoretically, a gamer could switch to the Complement application periodically and check whether any tasks are available for the gamer's hire. Alternatively, a gamer could set up notifications on a different device to provide alert that a task is available for their potential hire on the other console application software. Still, the ideal system structure would be if a gamer could opt-in to notifications from the Complement app on the video game console itself. That way, they could react to and accept or decline tasks most efficiently. The video game companies may be reluctant to buy into such a repurposing of their consoles and systems. The main downside of doing so is that it could dilute their console's brand values by making the entertainment system a tool for work. It might also eat into the console's computing power to have additional applications running simultaneously.

Another aspect of this issue is that many gamers have loyalties to certain platforms, and associated comforts with one vs. another. Their loyalty might be difficult to overcome as potential employers try to lure them into performing the types of productive applications considered by this disclosure, without buy-in of Microsoft, Sony, and Nintendo. For example, a video gamer might be inclined to accept a paid task if it could be completed right on the regular console where they would otherwise be playing a game. The same gamer might decline such an opportunity if it required plugging a retrofitted controller into the USB port of their Mac or PC. The difference in preference could be despite the fact that both systems have the same basic programming and functionality. The household would presumably have the same speed of internet for a Mac/PC-based interface as the console-based on. The same controller could be designed for a PC/Mac instance of the control system as for the console. Both systems would have AV-feedback provided real-time through a screen. But still, gamers have certain loyalties and comforts when it comes to their choice of consoles.

Other companies have created certain remote controls for cobots. However, the current offerings in the market are insufficient to solve the problems as contemplated here.

One observation is that robotics OEMs do provide connection ports to enable remote controls. It just typically is not a feature supported directly by the company. This is in part due to the open platform strategies of the robotics OEMs, as discussed earlier. The OEMs focus only on their robotic arm product and encourage third parties to spend money developing specific niches and applications. Those third parties reduce customer acquisition costs and allow the robotics OEMs to direct resources more heavily towards the core product line. Remote controls fall outside the purview of what OEMs consider their core arm product.

Existing commercial offerings are therefore limited in several ways, including:
a. Limited ease of use and intuitive HMI;
b. Limited audience, given the focus on the machine builder and integrator vs. end users and laypeople;
c. Inability to pull in a younger demographic of potential manufacturing workers;
d. Inability to utilize the skillsets of the gamer community, in particular their well-practiced dexterity over controllers to actuate target outcomes on a screen;
e. Inability to force a standardization of control systems across different robotics OEMs' hardware offerings

### SUMMARY

The human machine interface (HMI) contemplated in this disclosure provides a control system for controlling robotic systems. It is intuitive, consistent, and easy to use across different types of robots, in part because the HMI can be run on systems traditionally used for video gaming. Video game systems are designed to provide an intuitive user experience, as are cobots, making their combination an ideal one to unlock substantial value through the creation of remote controls.

The systems and methods described herein could first be used for remote process troubleshooting by existing employees of a company when in-person troubleshooting is inefficient, impractical, unsafe, or unavailable. Longer term, the methods described herein may enable a labor pairing model whereby remote robotics operators are matched with paid tasks as independent contractors. Last, the methods described herein would enable new forms of data capture to be leveraged for process automation.

Systems and methods contemplated herein would effectively redefine a labor market. Skills developed in the process of hobbyist video gaming would be redefined and repurposed for productive applications, in a transparent new “marketplace.” It is increasingly common knowledge that video gamers develop skills during the hobby that could be applicable to productive tasks in the real world. For example, video gamers are known to be dexterous in surgical rooms, battlefields, etc. However, there is clear underinvestment in leveraging and marketing those skills for productive applications. The video gamers lose out because they could be getting paid for their time, skills, and focus, all from the comfort of their own homes, and in a aspirational career path. Employers lose out because they could be hiring ideally suited, inexpensive, independent contractors remoting in on one-off bases to improve their operations, especially in the increasingly critical arena of industrial automation.

Video game systems (hardware and software) were created to be hobbyist hardware. This disclosure contemplates the repurposing of the existing hardware for productive applications. The hardware and software of Xbox, Playstation, and Nintendo are the existing environments where hobbyists (potential operators) already have immense comfort and passion from thousands of hours of gaming. Their familiarity and comfort with those specific, existing environments represents a major draw to entice operators with latent skills into productive applications they may not have previously considered.

Microsoft, Sony, and Nintendo layer massive restrictions on how their consoles can be used, and how software is run on them. This has inhibited such a repurposing in the past. They will continue to be reluctant about compromising the perception of and experiences in those environments they have carefully honed over time.

In order for a labor pairing model of remote robotics operations to come to fruition, a system must have defined criteria with which to sort operators and tasks. To use modern ridesharing applications as an example, both drivers and riders have “ratings” on a 5-star scale, visible to the other party. More recently, ridesharing apps request riders to provide feedback on more granular criteria such as music, conversation, car cleanliness, driving safety, etc. Similarly, vacation home hosts and guests provide rating and reviews of one another. Those ratings and reviews provide a basis upon which prospective hosts and guests can determine whether a booking is appropriate to each party in a targeted and granular manner.

With robotics operations, the skills and labor necessary to complete a task are even more heterogenous than driving skills, rider behavior, host accommodations, and guest tendencies. For example, if an employer needs an operator to complete/implement a welding task, they will want to know things such as: how many welds the operator has completed remotely in the past; how close to the desired seam the operator executed past welds; past employer satisfaction ratings; etc. By comparison, for a pick-and-place material handling application, as long as the material being handled is not fragile, the employer may not be particularly concerned about who performs the task, since the downside of failure is much lower. Nonetheless, an employer will want to make sure (i) the operator knows how to perform the most basic of operations and (ii) that they don't work for a competitor. The more heterogeneous the skills required for a given application, the more important it becomes to have a robust system to describe the relevant hiring details to potential employers.

Some embodiments will therefore incorporate carefully defined selection criteria to pair operators with tasks.

Leveraging the data of past tasks to inform future selection criteria. Some of the criteria listed will be determined by events that occur within the context of the system. For example, a rideshare driver's rating is defined by riders' feedback from rides that were arranged by the corresponding app. The ability to capture and retain that data for use as selection criteria is valuable.

Building selection criteria through training. In addition to tracking performance from previous jobs completed in-system to build and inform selection criteria, the system could incorporate performance from mock, training applications.

Notification systems. In order for a task pairing to be at all possible, both the operator and employer will need to be notified of the other's existence and willingness to consummate the task. As such, an effective and functional notification system will be necessary.

An important nuance of notification systems is that video games typically are not allowed to interrupt other software. For example, when a hobbyist is playing a video game, Xbox/Playstation/Nintendo will usually allow for notifications that another player came online, without fully interrupting the hobbyist's game. However, they will not allow for a different third party software to interrupt the current third party software, even if just for a simple notification. Enabling that functionality could create value: whereby the availability of an employer's task is pushed to hobbyists currently online, without fully interrupting the games they are playing. If the games had to be fully interrupted in order to make hobbyists aware of a task, they would be reluctant to enable the system.

Another related consideration on this topic is that as of now, video game consoles and systems do not allow for game software to provide notifications when the game itself is not being played. The only notifications that Microsoft/Xbox, Sony/Playstation, and Nintendo allow to be pushed to users during a give game are at the console/system-level. So, there is a sub-concept here for one third-party software to be allowed to notify a gamer while they are playing a different third party software.

Security. This system would by necessity open up an employer's operations to outside eyes. Some aspects of those operations may be trade secrets. Labor laws prohibit many forms of recording audio and video within factories. Transmitting those recordings makes those prohibitions even more fraught. As such, employers will be reluctant to utilize this type of system unless they can be told with confidence that the operator is legitimate, and not motivating by corporate espionage on behalf of a (potential) competitor. Perhaps a sub-idea in this category would be a sub-system that allows for an operator to agree to some form of non-competition with certain other employers or types of operations, thereby ensuring that what the employer pays for becomes more “proprietary” and valuable to the employer.

Recording of data for AI purposes. In order for the system to work, an operator's control inputs in the operator environment will by necessity be translated to a digital format, transmitted to the actuation environment, and converted into true physical actuation. This opens up a huge opportunity for machine learning systems to compare an operator's control inputs with audio-visual cues being transmitted back, all in real time. With appropriate data analytics, a system of AI and machine learning could eventually derive the patterns necessary to perform operations without input from a human operator.

In some embodiments, a method is provided for controlling a robotic unit. Such a method may include operating the robotic unit to autonomously perform at least one task, identifying a portion of the at least one task to be manually executed or supervised, and selecting an offsite target handler for manually executing or supervising the portion of the at least one task.

Once selected, the method then transmits a request to the target handler selected. Upon receiving an indication of acceptance of the request from the target handler, the method provides the target handler with a remote control interface by which the portion of the task may be manually executed or supervised. The method may then receive, at the remote control interface, control inputs for the robotic unit. The method may then provide, at the remote control interface, an information feed including real time status information for the robotic unit.

The method may then confirm that the portion of the at least one task has been completed and terminate the remote control interface.

In some embodiments, the identification of the portion of the at least one task to be manually executed or supervised comprises identifying a failure of the robotic unit to autonomously complete a task. The portion is then to be manually executed.

In some embodiments, the identification of the portion of the at least one task to be manually executed or supervised comprises identifying a task not previously executed by the robotic unit.

In some embodiments, the autonomous operation of the robotic unit is by way of a learning algorithm, and the identification of the portion of the at least one task to be manually executed or supervised comprises identifying a task for which the robotic unit has insufficient training data.

In some such embodiments, the portion of the at least one task is to be supervised by the target handler. The target handler may then choose to intervene by way of the remote control interface, thereby overriding an autonomous attempt by the robotic unit. In some such embodiments, upon intervention by the target handler, control inputs received by way of the remote control interface are recorded and incorporated into the training data.

In some embodiments in which autonomous operation is by way of a learning algorithm, the learning algorithm is a convolutional neural network (CNN) and the CNN is trained using prior iterations of the portion of the at least one task. Upon confirming that the portion has been completed, control inputs received by way of the remote control interface are incorporated into the training data.

In some embodiments, selecting the offsite target handler comprises retrieving, from a database, a list of potential target handlers available for executing the portion of the at least one task. For each of the potential target handlers, the method then computes a compatibility score for ranking the likelihood that the potential target handler would complete the portion of the task if selected. The method then selects the offsite target handler based on the corresponding compatibility score.

In some such embodiments, the potential target handlers are people having video game experience, and the compatibility score is at least partially based on a measure of video game experience associated with the corresponding potential target handler.

In some such embodiments, the measure of video game experience is a ranking in the context of a video game console, a specific video game, a defined video game league, or an esports league, the ranking reflecting a level of skill or an amount of time interacting with the video game console, specific video game, defined video game league, or esports league.

In some embodiments leveraging a compatibility score, the compatibility score is at least partially further based on at least one of proximity to a physical location of the robotic unit to be operated, employment status, employment history, experience with robotics, referrals, internet connection quality of the corresponding potential target handler, and prior participation history in control of the robotic unit.

In some embodiments leveraging a compatibility score, the remote control interface is provided at a video game console. In some such embodiments, the measure of video game experience is associated with the video game console, and the remote control interface is provided at the corresponding video game console.

In some embodiments in which the remote control interface is provided at a video game console, the transmitting of the request to the target handler is by way of a user interface different than the video game console. In some such embodiments, the transmitting of the request is by way of a personal electronic device utilizing push notifications.

In some embodiments in which a compatibility score is used, upon receiving a refusal of the request from the target handler identified, or upon a passage of a threshold period of time, the method selects a second offsite handler based on the compatibility score and transmits a second request to the second target handler, the second request replacing the initial request transmitted.

In some embodiments in which a compatibility score is used, the list of potential target handlers comprises employees of an entity implementing the method.

In some embodiments, the remote control interface is an application installed at a user interface of the target handler, and the providing of the remote control interface by which the task may be manually executed or supervised comprises the provision of access to an instance of the remote control interface associated with the portion of the at least one task. In some such embodiments, the transmitting of the request to the target handler identified is by way of a user interface different than the installed application.

In some embodiments, the remote control interface is provided by way of a video game console, and the control inputs are received at the video game console by way of video game controllers.

In some embodiments, the information feed comprises a video and audio feed from the robotic unit operated.

In some embodiments, the method further comprises issuing payment to the target handler upon confirming that the portion of the at least one task has been completed.

In some embodiments, a method is provided for training a robotic unit in which the method includes identifying a portion of at least one task to be manually executed, transmitting a request to a target handler for manually executing the portion, the target handler having a remote control interface by which the task may be manually executed, and receiving, at the remote control interface, control inputs for the robotic unit.

The method provides, at the remote control interface, an information feed including real time status information for the robotic unit, and records, in a database, the control inputs received at the remote control interface. The method then confirms that the portion of the at least one task has been completed, and utilizes the control inputs recorded in the database for training a learning algorithm for autonomously controlling the robotic unit.

In some embodiments of a training method, the method further includes recording the information feed in the database, wherein the information feed is utilized with the control inputs recorded for training the learning algorithm.

In some embodiments of a training method, the robotic unit operates autonomously to perform the at least one task, and wherein the identifying of a portion of the at least one task is by evaluating a plurality of portions of the at least one task and determining that the robotic unit would fail to complete the portion identified if the robotic unit attempted to perform the portion autonomously or that the robotic unit has attempted and failed to complete the portion identified.

In some such embodiments, the autonomous operation of the robotic unit is based on the learning algorithm being previously trained to complete portions of the at least one task, and wherein the identification of the portion is by determining that the robotic unit has been provided with insufficient training data for the portion.

In some such embodiments, the learning algorithm is a convolutional neural network (CNN) and wherein the training data is derived from previous iterations of implementations of the at least one task. In some such embodiments, the database is a database of training data for the CNN, and upon confirming that the portion of the at least one task has been completed, the CNN is further trained to execute the portion of the at least one task based on the control inputs recorded.

In some embodiments relying on a CNN, the remote control interface allows the target handler to monitor the execution of the portion of the at least one task and intervene during autonomous operation of the robotic unit, and upon intervention by the target handler, control inputs received by way of the remote control interface are recorded in the database and incorporated into training data.

In some embodiments of training methods, the target handler is offsite from the location of the robotic unit and is selected upon identifying the portion of the at least one task to be manually executed, and the transmitting of the request is to the selected target handler.

In some such embodiments, selecting the target handler is by retrieving, from a database, a list of potential target handlers available for executing the portion of the at least one task, computing a compatibility score for ranking the likelihood that each of the potential target handlers would complete the portion of the task if selected, and selecting the target handler based on the corresponding compatibility score. In some such embodiments, the potential handlers are people having video game experience, and wherein the compatibility score is at least partially based on a measure of video game experience associated with the corresponding potential target handler.

In some such embodiments, the remote control interface is provided by way of a video game console, and wherein the control inputs are received at the video game console by way of video game controllers.

In some embodiments leveraging a compatibility score, such a score is at least partially based on at least one of an assessed skill level of the potential target handler, proximity to a physical location of the robotic unit to be operated, employment status, employment history, experience with robotics, internet connection quality of the corresponding potential target handler, and prior participation history in control of the robotic unit.

In some such embodiments, the portion of the task is assigned a complexity rank based on an assessed difficulty of the portion, and the compatibility score is weighted more heavily towards an assessed skill level of the potential target handler for a portion having a higher assessed difficulty than for a portion having a lower assessed difficulty.

In some such embodiments, the robotic unit operates autonomously to perform the at least one task based on a learning algorithm trained on training data to complete portions of the at least one task, and the portion of the at least one task identified has insufficient training data for autonomous operation, and wherein the assessed difficulty is based at least partially on an amount of training data available for the portion.

In some such embodiments, a portion having no available training data is assessed as having a higher difficulty than a portion having insufficient available training data.

In some embodiments where assessed difficulty is based on sufficiency of training data, upon confirming that the portion of the at least one task has been completed, the learning algorithm is further trained to execute the portion of the at least one task based on the control inputs recorded.

In some embodiments relying on a compatibility score, the portion of the task is classified based on a category of task of which it is a portion, and the compatibility score is weighted more heavily towards a prior participation history in control of the robotic unit or employment history related to robotic control in the category of task.

In some embodiments, a robotic system is provided having a robotic unit having a manipulation tool configured to execute at least one task, a memory containing instructions for operating the robotic unit to execute the at least one task, processing circuitry for operating the manipulation tool based on the instructions, and a communications interface by which the robotic unit can be controlled remotely.

The instructions in the memory include training data for a learning algorithm, and the instructions cause the robotic unit to operate autonomously to perform portions of the at least one task based on an output of the learning algorithm, identify a portion of the at least one task for which the training data is insufficient, select an offsite target handler for manually executing the portion of the at least one task, and transmit, by way of the communications interface, a request to the target handler selected.

Upon receiving an indication of acceptance of the request from the target handler, the system provides the target handler with a remote control interface by which the task may be manually executed, receives, at the remote control interface by way of the communications interface, control inputs for the robotic unit, record, at the memory, the control inputs received, and incorporate the control inputs received into the training data.

### BRIEF DESCRIPTION OF THE DRAWINGS

FIG. 1 is a schematic diagram for a system for implementing a remote control robotic system.

FIG. 2 illustrates a method for controlling a robotic unit in a system such as that illustrated in FIG. 1.

FIG. 3 illustrates a method for training a robotic unit in the context of a system such as that illustrated in FIG. 1.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

This disclosure relates to a novel human-machine interface to operate robots remotely and intuitively. The system generally provides functionalities in at least two networked environments: the “operator environment” and “actuation environment.”

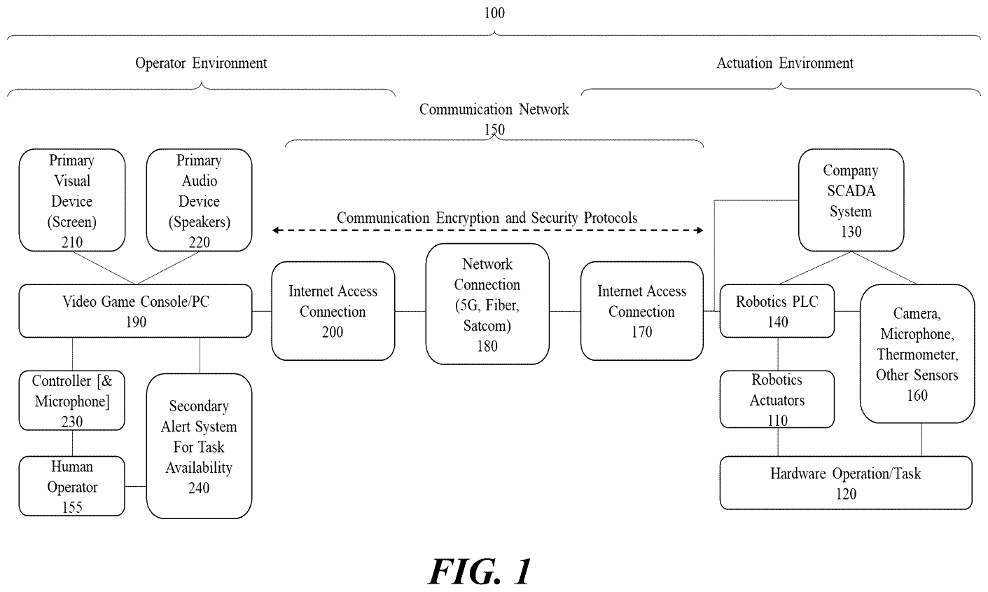

FIG. 1 is a schematic diagram for a system for implementing a remote control robotic system 100.

As shown, the remote control robotic system 100 may include a robotic unit 110, such as a robotic actuator, having a manipulation tool configured to execute at least one task 120. The system would typically also have a memory containing instructions for operating the robotic unit to execute the at least one task and processing circuitry for operating the manipulation tool based on the instructions. Such memory and processing circuitry may be incorporated into a supervisory control and data acquisition (SCADA) platform 130 owned by a company implementing the robotic system 100. Alternatively, or in addition, a separate robotics programmable logic controller (PLC) 140 may be provided.

In some embodiments, the robotics PLC 140 may contain the memory and processing circuitry and may thereby control the robotic unit 110 as a standalone controller. In other embodiments, such as that illustrated, the company SCADA platform 130 may control the robotic unit 110 by way of the PLC 140. For example, the SCADA platform 130 may determine an overall schematic for multiple robotic units 110 or may determine a task to be performed by a particular robotic unit, while the robotics PLC 140 may function to control individual movements or learned behaviors of the robotic unit 110 in order to execute the tasks identified by the SCADA platform.

Generally, the robotic unit 110 may generate real time status information related to the behavior of the robotic unit 110 taken alone and/or in the context of a larger robotic system 100 which may contain multiple robotic units. In some embodiments, such as that shown, the robotic system 100 may further include various sensors, such as thermometers, cameras, and microphones 160 separate from the robotic unit 110 itself which may collect additional real time status information about the robotic unit 110 or about the operation or task 120 being performed. Accordingly, the robotic unit 110 may provide information related to, for example, actuator position in space, actuator configuration (i.e., whether an actuator is open or closed), and any resistance encountered by a robotic limb in performing a task.

At the same time, additional sensors, including thermometers, cameras, and microphones 160 may generate a video and/or audio feed as well as providing information about, for example, detected temperatures. Such sensors, cameras, and microphones may be mounted on or adjacent the robotic unit 110 or may be separately focused on the operation or task 120 being performed by the robotic unit. An information feed may then be generated from available sensors, cameras, and microphones 160 and may be paired with, or may further include, any information generated by the robotic unit 110 itself.

The robotic system 100 also includes a communications network 150 by which the robotic unit 110 can be controlled remotely. The information feed may be transmitted to a party 155 selected to handle the robotic unit 110, referred to herein as a “handler” or a “target handler,” by way of the communications interface or network 150, and any control inputs provided by the handler 155 may be sent back to the robotic unit 110 by way of the communications network 150. Generally, the communications interface or network 150 is connected to the robotic unit 110 by way of one or both of the PLC 140 and the SCADA platform 130. Accordingly, the SCADA platform 130 and/or the PLC 140 may be provided with a network access connection interface 170 which links it to a network connection 180. The network 180 may then in turn be connected to a user interface 190 accessible by the handler 155 by way of a second network connection interface 200. Generally, the network connection interfaces 170, 200 may be internet access points, and the network itself 180 may be the internet. As such, the physical layer of the network 180 may be by way of 5G, fiber, satellite communications, or any other standard internet connection available between the handler 155 and the SCADA platform 130 or PLC 140.

The user interface 190 may be a video game console or PC accessible by the handler, and the user interface would typically be provided with at least a visual device 210 such as a screen and an audio device 220, such as speakers or headphones. The user interface 190 is controllable by the handler 155 by way of a controller 230. The controller 230 may be, for example, a video game controller compatible with the video game console or PC 190 being used as the user interface.

In some embodiments, a secondary user interface 240 may be provided so as to provide notices to a target handler 155 outside of the context of software running on the primary user interface 190. For example, if a target handler 155 is not at their video game console 190, or if they are using software on the video game console that does not allow for interruption by the system 100, an alert can be provided to the target handler 155 by way of the secondary user interface 240. The secondary user interface 240 may be, for example, the target handler's 155 cell phone.

Accordingly, within the operator environment, the system 100 includes of a controller 230, a computer, such as a video game console 190, audio/visual feedback devices (i.e., screen 210 and speaker 220), and an internet access connection 200. Within the actuation environment, the system includes the company's Supervisory Control and Data Acquisition (“SCADA”) system 130, the robotics Programmable Logic Controller (“PLC”) 140 and sensors such as camera, microphone, thermometer, accelerometer, etc. 160. Between the two environments exists a communication network 150 with appropriate encryption and other security protocols.

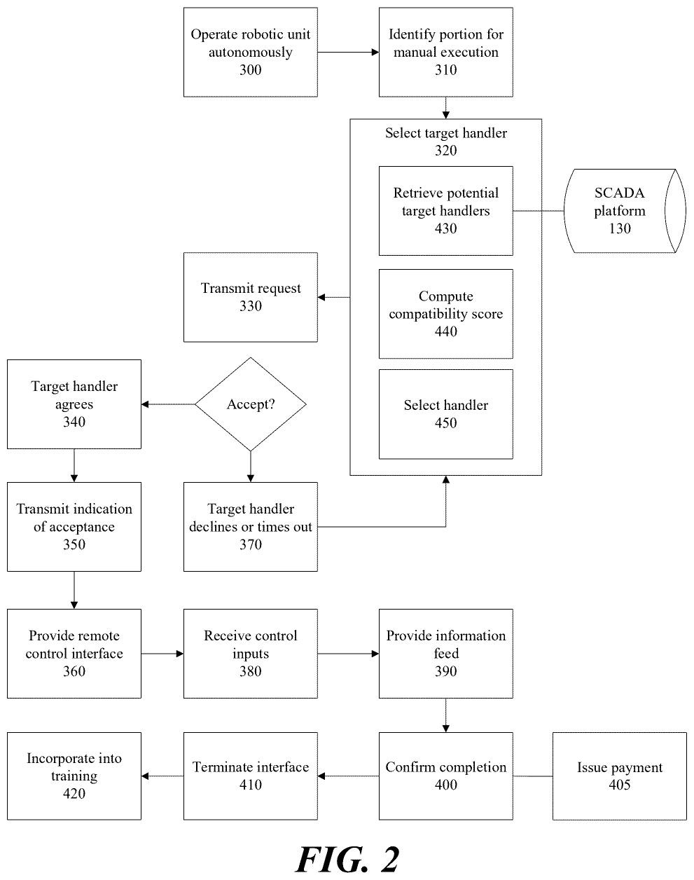

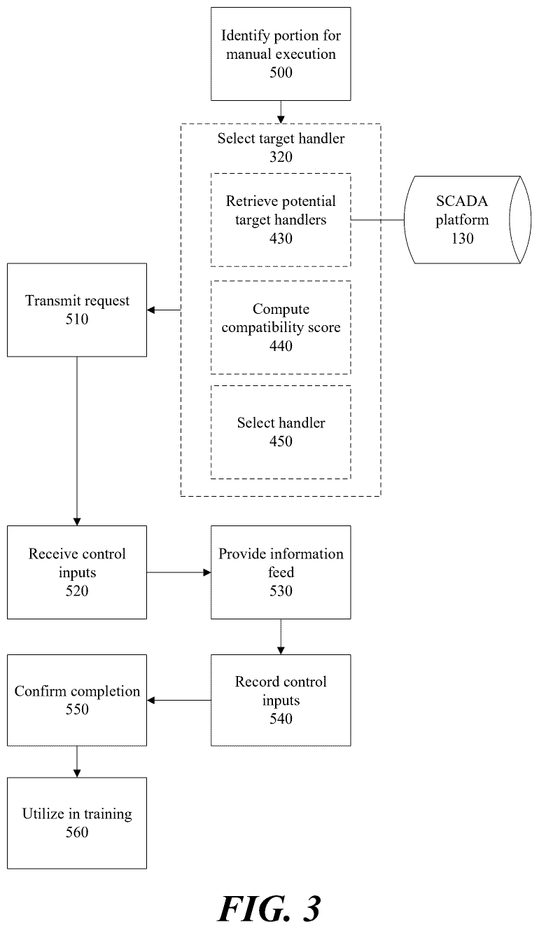

As discussed in more detail below with respect to the methods of FIGS. 2 and 3, instructions in the memory may include training data for a learning algorithm that can be used to control the robotic unit 110. The instructions can then cause the robotic unit to operate autonomously to perform portions of the at least one task 120 based on an output of the learning algorithm. The task may be a wide variety of tasks, such as pick and place processes, welding processes, or any other processes a robotic unit 110 may be expected to implement. The learning algorithm may be any number of learning algorithms, such as a neural network, which may be a convolutional neural network (CNN).

The instructions may allow the PLC 140 or SCADA platform 130 to identify a portion of the at least one task 120 for which the training data already in memory is insufficient. The PLC 140 or SCADA platform 130 may then select an offsite target handler 155 for manually executing the portion of the at least one task 120. It is noted that the target handler 155 referred to herein is generally offsite, to distinguish the method, which contemplates control by a target handler by way of a communication network 150, such as the internet. Traditionally, a control system for the robotic unit 110, such as the PLC 140 is onsite and directly controls the robotic system 100. Manual control is typically executed by way of the PLC 140 or some other onsite controller.

Further, the target handler 155 may be one of several potential target handlers and may be selected by the robotic system 150 once the system determines that manual execution or supervision is required.

The PLC 140 or SCADA platform 130 then transmits, by way of the communication network 150, a request to the target handler 155 selected. Such a request may be sent to the user interface 190 directly and/or it may be sent to the secondary user interface 240.

Upon receiving an indication of acceptance of the request from the target handler 155, the system 100 may provide the target handler with a remote control interface by which the task may be manually executed. Such a remote control interface may be a software application operable at the user interface 190, such as a video game console, in order to control the robotic unit 110. Such a software application may already exist at the target handler's 155 user interface 190, and as such, the system 100 may then simply provide access to an instance of the user interface 190, or access to the robotic unit by way of the already loaded software application. This may be by establishing a connection between the software and the SCADA system 130 or the PLC 140.

Once the target handler 155 has access to the system 100, the system receives, at the remote control interface loaded at the user interface 190 by way of the communications interface 150, control inputs for the robotic unit 110.

As discussed in more detail below, the system may do a variety of things with the control inputs received by way of the communications interface 150 from the controller 230. As such, the control inputs may be used by the PLC 140 to directly control the robotic unit 110 and the system 100 may, simultaneously, record, at the memory of the SCADA platform 130 or the PLC 140, the control inputs received. As such, in addition to allowing the target handler 155 to control the robotic unit 110 and thereby complete the task 120, the system can incorporate the control inputs received into the training data, allowing for more robust control in future instances of similar tasks 120.

Accordingly, a human operator 155 will be made aware of a task 120 or a portion of such a task available to them for execution through a notification on the primary audio/visual devices 210, 220 in the operator environment. This notification on the primary audio/visual devices typically does not cause a complete interruption of any underlying system operations of the Video Game Console/PC 190 and may be, for example, a popup notification. A notification may also be sent to the operator through a secondary peripheral notification device 240, such as a smartphone. If the operator, referred to herein as a handler, or target handler 155, does not accept or the request times out, the task is withdrawn and offered to another potential target handler 155. If and when a target handler 155 accepts the task, the main Complement software is launched. The operator, or target handler 155, is then provided with instructions, and an audio-visual feedback loop of the actuation environment initiates. The operator provides inputs through the controller 230 that cause actuation of the robot 110 in the actuation environment. The operator 155 will continue to provide inputs until the audio-visual feedback indicates to the operator that the target outcome has been reached. The SCADA system 130 is prompted to verify that the task 120, or portion of the task, is complete. If completion of the task 120, or portion of the task, is verified, the audio-visual feedback loop is closed, compensation may be accrued to the operator 155, and the operator can go back to any alternative use of the video game console/PC 190.

The operator 155 could be an existing employee of the company requesting their labor for the specific task 120 or portion of the task. Alternatively, the operator 155 could be an independent contractor. The system 100 allows for iterative offers to be made in order for the task 120 or portion of the task to be completed in a prompt, organized manner. The system 100 is capable of pairing laborers with employment tasks 120 based on myriad criteria including past relevant experience, cost, security verification, credentials, qualifications, trade association affiliation, referrals, employer satisfaction ratings on past tasks, or otherwise.

The invention can be used for many types of tasks. These include but are not limited to material handling (including pick-and-place), welding, assembly, dispensing, finishing, machine tending, material removal, grinding, and quality inspections.

The needs for remote control within these applications are various. The most straightforward relates to error correction. If an operational error occurs and an employee is not available to correct it promptly in person, remote access may provide a faster, alternative means of error correction. By speeding up the correction, the negative impacts of the error are reduced (e.g., lost production, damage). Another need for remote control within these applications arises when a project manager looks to implement a new system (i.e., traditional system implementation). After an automation project commences and costs start to be incurred, it is a race to completion, in order to start realizing the offsetting benefits as soon as possible, thereby making the project worthwhile. Another use case involves using remote control when in-person human control could cause discomfort or harm, such as extreme temperatures, radiation, etc.

During an operation, the target handler's 155 control inputs and audio-visual feedback can be recorded. Those digital recordings are available for data analytics, pattern identification, and applications of AI in future iterations of comparable tasks. Recordings can be referenced for future operational corrections of the same robotic system. They can be leveraged to inform best practices of new robotic implementations. Recordings can be analyzed to generate artificial intelligence for various other comparable situations.

FIG. 2 illustrates a method for controlling a robotic unit 110 in a system 100 such as that illustrated in FIG. 1.

As shown, the method typically involves operating (300) the robotic unit 110 in order to autonomously perform at least one task 120. A robotic system 100 may have a large number of robotic units 110 generally involved in performing such tasks 120. For example, in a factory environment, robotic units 110 may be involved in performing various functions involved in manufacturing such as, for example, welding or machining.

During such autonomous operation, the method may identify (310) a portion of the at least one task 120 to be manually executed or supervised. This may be due to a failure of the robotic system 100 to complete the task autonomously, or it may be due to a preemptive determination that the robotic system 100 cannot implement such a task autonomously. For example, the method may generally operate under a machine learning algorithm that has previously been trained, and it may identify a portion of a task either not previously executed by the robotic system 100 or a particular robotic unit 110 now tasked with completing the task. Similarly, it may determine that the system 100 has insufficient training data in order to complete the identified portion of the task 120.

For example, in some embodiments, the method may identify a portion of the task 120 that the autonomous system has failed to execute and requires human intervention. For example, if the robotic unit 110 was attempting to pick up a package and place it at a target location, but the robotic unit 110 missed its mark or knocked over a package while performing autonomously, the system 100 may require such intervention to complete such a task 120. It is understood that in this disclosure references to a task 120 and a portion of such a task 120 are somewhat interchangeable. The intent is that a task 120 may include various portions, and that when the system 100 identifies some action that requires manual execution, it typically only requires manual execution for some portion of a larger task 120. For example, the task 120 may be the movement of several hundred packages from pallets to a conveyor, and the portion may be the movement of one of those packages that was not recognized or that was knocked over inadvertently. It is understood that the “portion” may, in some cases, be a complete task 120 that requires intervention.

As an example of a task 120 for which insufficient training data has been provided, autonomous systems are often trained on a variety of training data. Such data may be prior iterations of similar tasks performed by the system. Much of this training data is generated by having a human first execute the task by way of the robotic system 100 and using such a prior execution as a template for future autonomous activity by the robotic system. Providing a large number of examples of such a task may allow many learning systems to generalize based on variations among the examples. However, where a particular task is outside of a range or scope of the training content, such as an attempt to pick up a package sized or shaped differently than previous instances, the robotic system 100 may determine that the robotic unit 110 could potentially fail, or is likely to fail, if the task is attempted autonomously.

If the system 100 determines that the robotic unit 110 could potentially fail, the system may select the portion of the task 120 and request supervision. Alternatively, if the system 100 determines that the robotic unit 110 is likely to fail, or has already failed, the system may request non-autonomous execution of the portion of the task 120.

In such an instance, the method may select (320) an offsite target handler 155 for manually executing or supervising the portion of the at least one task 120. Upon such a selection (at 320), the method may transmit a request (330) to the target handler 155 requesting that the target handler execute or supervise the portion of the task 120. Such a request may be generated at the company SCADA platform 130 or PLC 140 and may be transmitted to the target handler 155 by way of the communication network 150. The request may include details related to the task so that the target handler 155 selected may consider the task 120. Additionally, the request may include addition details related to the target handler's participation, such as a proposed payment for execution of the portion of the task 120, a calculated difficulty level of the task, criteria for evaluating completion of the task, and some measure of compatibility between the task and the target handler 155.

The target handler 155 may then choose to accept (340) the request (transmitted at 330) and thereby agree to manually execute or supervise the portion of the task 120. In such a scenario, the method typically receives an indication of acceptance (350) of the request from the target handler 155 and proceeds to provide the target handler with a remote control interface (360) which can then be used to manually execute or supervise the portion of the task 120. Such a remote control interface may be an application on a user interface already owned by the target handler 155, such as a video game console or PC 190. It is understood that while a video game console is referenced throughout, in some scenarios, an alternate user interface may be provided as well. In such a scenario, the provision of the remote control interface (360) may take the form of providing the corresponding application for download or may instead take the form of providing access to an instance of the application previously loaded on the target handler's 155 video game console 190 or the like. For example, the provision of the remote control interface (at 360) by the method may take the form of transmitting an access code or requesting participation in a session of the software.

In some embodiments, where the target handler 155 declines (370) the request (transmitted at 330), the method may proceed to select an alternate target handler 155 (at 320) and transmit a corresponding request (at 330). In some such embodiments, the target handler 155 may proactively decline (at 370) the request (transmitted at 330). Alternatively, in some embodiments, if a threshold period of time has passed since the transmission of the request (at 330), the method may select a second offsite handler, such as based on the compatibility score discussed below, and transmit a second request to the second target handler 155, the second request replacing the initial request transmitted.

In many implementations of the method described herein, time is valuable, and any time spent waiting for a potential target handler 155 to respond is time during which the robotic unit 110 is inactive and awaiting instructions. As such, a time threshold could be set to ensure that a request sent to, for example, a sleeping potential target handler, does not linger. In such embodiments, if a request (sent at 330) is not accepted within, for example, 10 minutes, or an hour, a follow up request may be sent to a different party.

Once the remote control interface provided (at 360) has been accessed by the target handler 155, the method receives (380), at the remote control interface, control inputs for the robotic unit 110. Such control inputs may be provided by the target handler 155 by way of a controller associated with the video game console 190 and are typically transmitted to the company SCADA platform 130 or the PLC 140 by way of the communication network 150.

At the same time, the method provides (390), at the remote control interface, an information feed, by way of the communication network 150. Such an information feed may comprise, for example, a video and audio feed from the robotic unit 110. This may be provided by the robotic unit 110 itself or from various sensor hardware, including one or more camera and microphone 160, provided at or near the robotic unit 110.

The information feed provided (at 390) may also include additional information associated with the robotic unit, such as status or location information associated with various robotic actuators. During use, portions of the information feed may be either provided directly to the target handler 155, such as in the form of video by way of a monitor 210 and audio by way of a speaker 220 or interpreted by the remote control interface and presented to the user in the context of the user interface. As such, sensor data may be provided to the user, or may be provided to the target handler 155 in an intuitive way through their display.

In this manner, the target handler 155 may control the robotic unit 110 by way of the controller 230 and video game console 190 in order to execute or supervise the portion of the task 120. Upon confirming (400) that the portion of the task 120 has been completed, the method typically terminates (410) the remote control interface. In some embodiments, where payment is to be issued to the target handler 155, such payment may be issued upon confirming completion of the portion of the task (at 400).

As noted above, in some embodiments, the method may determine that the portion of the task 120 could potentially fail if performed autonomously (rather than determining that it is likely to fail or has already failed). In such embodiments, the method may first request that the target handler 155 supervise the portion of the task 120 rather than manually execute the task. In such an embodiment, the portion of the task 120 is supervised, and the target handler 155 may choose to intervene by way of the remote control interface, thereby overriding an autonomous attempt by the robotic unit 110.

As noted above, the determination by the system 110 (at 310) that the portion of the task 120 requires manual execution or supervision may be by determining that insufficient training data is available for the portion. In such embodiments, where the system determined that manual supervision was appropriate but the target handler 155 chose to intervene, control inputs received by way of the remote control interface are recorded and incorporated into training data (420). In many such embodiments, the control inputs are recorded with at least a portion of the information feed to which such control inputs were responsive.

As noted above, the method described herein may rely on learning algorithms, such as neural networks, and in particular, convolutional neural networks (CNN). As such, the CNN may be trained using prior iterations of the portion of the at least one task 120. In such embodiments, upon confirming that the portion has been completed (at 400), the control inputs received by way of the remote control interface, and in many embodiments, the corresponding information feed, may be incorporated into training data (at 420).

When selecting an offsite target handler 155 for executing or supervising the portion of the task 120 (at 320), the method may first retrieve (430), from a database a list of potential target handlers. Such a database may be provided in the SCADA platform 130 associated with implementing the task 120. Accordingly, for each potential target handler 155, the method may compute a compatibility score (440) for ranking the likelihood that the potential target handler would complete the portion of the task if selected.

In some embodiments, the list of potential target handlers 155 may be limited, such as to employees of an entity implementing the method. In other embodiments, the list of potential target handlers 155 may be any number of users who have signed up to participate in the corresponding system 100. In some embodiments, different databases or different groups of potential target handlers 155 may be available based on details associated with the task, such as the potential for confidentiality requirements.

The method may then select (450) the offsite target handler 155 based on the corresponding compatibility score prior to transmitting the request (at 330). If the most compatible target handler 155 declines the request (at 370), the method may proceed to select the following target handler 155 based on the ranking of compatibility scores (at 440).

In many embodiments, the user interface 190 is a video game console, as discussed above. As such, the potential target handlers 155 in the database may be gamers, or people having video game experience. The compatibility score may then be at least partially based on a measure of video game experience associated with the corresponding potential target handler 155. For example, such a measure of video game experience may be a ranking in the context of a particular video game console, a specific video game, a defined video game league, or an esports league. In such an embodiment, the ranking may be assumed to reflect a level of skill or an amount of time interacting with the corresponding video game console, specific video game, defined video game league, or esports league.

Generally, if the remote control interface is provided at a video game console 190, the measure of video game experience is associated with that video game console, and the remote control interface is provided at the corresponding video game console.

In some embodiments, the compatibility score may be at least partially based on a variety of factors. Such factors may include proximity to a physical location of the robotic unit 110 to be operated. Such a factor may render a particular potential target handler 155 more likely to successfully complete the portion of the task 120 because physical proximity may reduce latency, or lag, due to the communication network 150, and may thereby increase the likelihood of success for any given skill level.

Similarly, a user's internet connection quality at their internet access connection 200 may be considered when determining how they should be ranked as a potential target handler 155.

Other factors may include the potential target handler's 155 employment status or employment history, as such status or history may indicate familiarity with the particular task the robotic unit 110 is attempting to complete. For example, if the potential target handler 155 is a welder or has previously been employed as a welder, he may be more likely to successfully complete portions of corresponding tasks 120.

Similarly, the compatibility score may be partially based on a potential target handler's previous experience with robotics. In some embodiments, referrals may be considered as well. For example, if a user has been utilized as a target handler 155 by the system 100 for previous tasks, then they may be recommended by a particular supervisor, or the system itself may generate a ranking which may function as a positive referral. Accordingly, prior participation history in control of the robotic unit 110 or other such units in the system 100 may be considered.

Additional factors may be considered as well. For example, if a particular target handler 155 has a set price for which they are willing to manually execute portions of tasks 120, or if the target handler has a known skill level associated with a particular category of task, such factors may be considered.

The factors identified herein may be further considered in concert. For example, proximity to a physical location may imply that a particular target handler 155 may be available to meet with a potential employer in person. Accordingly, physical proximity may be a positive factor not just because such proximity may reduce latency, but also because sorting potential target handlers 155 at least partially by proximity may generate other advantages related to such proximity. This approach may also result in certain target handlers 155 being selected more often by local employers, resulting in additional familiarity.

The method may utilize the various factors of the compatibility scores in various ways and may, in some embodiments, utilize AI methods to determine the impact of individual factors on the ability of a potential target handler 155 to successfully complete portions of corresponding tasks 120.

In some embodiments, a secondary user interface 240 may be provided in order to provide alerts to a user. Where the user interface 190 is a video game console, for example, the video game console may not allow for an alert to be generated by an inactive software program. Accordingly, while a potential target handler 155 is playing a video game at the video game console 190, they may be an ideal target handler for the method described herein. However, a video game may not allow for any communication with the target handler 155 by way of the video game console 190 outside of the video game itself.

Accordingly, when the method transmits the request (at 330) to the target handler 155, the request may be transmitted by way of a secondary user interface 140 different than the video game console 190. For example, as noted above, the request may be sent by way of a personal electronic device 140, such as a user's cell phone, utilizing push notifications.

As discussed above, the method of FIG. 2 may be used to control a robotic unit 110 while it generally operates autonomously, such that specific portions of tasks 120 can be manually performed in the context of a generally autonomous system implementation. Some variations of such a method may be utilized in order to train a robotic unit. While the method discussed with respect to FIG. 2 mentions the use of control inputs to train the system for future iterations, FIG. 3 more directly illustrates a method for training a robotic unit 110 in the context of a system 100 such as that illustrated in FIG. 1.

It will be understood that the method of FIG. 3 is provided in order to highlight variations of the method discussed above with respect to FIG. 2, and to highlight implementations in which certain steps discussed above are not required. As shown, the method for training the robotic unit 110 first identifies (500) a portion of at least one task 120 to be manually executed. The method then transmits (510) a request to a target handler 155 for manually executing the portion of the task.

Generally, the target handler 155 has or is provided with a remote control interface by which the task may be manually executed. As discussed above, such a remote control interface may be provided in the context of a video game console 190.

The method then receives (520), at the remote control interface, control inputs for the robotic unit 110 and provides (530) at the remote control interface, an information feed, including real time status information for the robotic unit. Such control inputs may be provided from the video game console 190 to the robotics PLC 140 or the company SCADA platform 130 by way of the communication network 150, as discussed above.

Similarly, the information feed may comprise information drawn from the robotic unit 110 itself and/or sensors, cameras, and microphones 160 associated with the robotic unit 110 or the system 100 and may be transmitted from the PLC 140 or the SCADA platform 130 to the video game console 190 by way of the communication network 150. The data from the information feed may then be presented to the user at a monitor 210 and speakers 220, and the control inputs may be generated using a controller 230.

The method may proceed to record (540), in a database, the control inputs received at the remote control interface. Similarly, in some embodiments, the information feed, or portions thereof, may be recorded as well, and the information feed may be collated with the control inputs.

The method may then confirm (550) that the portion of the at least one task 120 has been completed. Upon confirming the same, the control inputs recorded in the database are utilized (560) for training a learning algorithm for autonomously controlling the robotic unit 110. Where the information feed is collated with the control inputs, the data could be combined to more effectively train the learning algorithm.

As discussed above, such a learning algorithm may be, for example, a neural network, such as a convolutional neural network (CNN).

In many such embodiments, such as those discussed above with respect to FIG. 2, the method further provides for the robotic unit 110 to operate autonomously to perform the at least one task 120 (see FIG. 2 at 300), The identification of the portion (at 500) of the at least one task 120 is then by evaluating a plurality of portions of the at least one task and determining that he robotic unit 110 would fail to complete the portion identified if the robotic unit attempted to perform the portion autonomously. Similarly, the method may identify the at least one task (at 500) by determining that the robotic unit 110 has attempted and failed to complete the portion identified.

The identification of the portion of the at least one task 120 may be by determining that the robotic unit 110 or the system 100 has been provided with insufficient training data for the portion. For example, the learning algorithm may be a CNN, as noted above, and the training data may be derived from previous iterations of implementations of the at least one task. A particular portion may not have been previously performed by the robotic unit 110 or may not have been performed enough times to properly train the robotic unit. Accordingly, upon confirming (550) that the portion of the at least one task 120 has been completed, the CNN may be further trained to execute the portion of the at least one task based on the control inputs recorded.

In some embodiments, instead of implementing manual control, the target handler 155 may instead monitor the execution of the portion of the at least one task 120 and intervene during autonomous operation of the robotic unit 110. Upon intervention by the target handler 1550, control inputs received by way of the remote control interface are recorded in the database and incorporated into training data (at 560).

In some embodiments, the target handler 155 is offsite from the location of the robotic unit 120. The target handler 155 may then be selected upon identifying (at 500) the portion of the at least one task 120 for manual execution. The transmitting of the request (at 510) is then to the selected target handler.

The selection of an appropriate target handler 155 is shown in more detail above with respect to the embodiment of FIG. 2, but a similar process may be implemented in implementations focused on training.

Accordingly, when selecting an offsite target handler 155 for executing or supervising the portion of the task 120, the method may first retrieve (430), from a database a list of potential target handlers. Such a database may be provided in the SCADA platform 130 associated with implementing the task 120. Accordingly, for each potential target handler 155, the method may compute a compatibility score (440) for ranking the likelihood that the potential target handler would complete the portion of the task if selected.

In some embodiments, the list of potential target handlers 155 may be limited, such as to employees of an entity implementing the method. In other embodiments, the list of potential target handlers 155 may be any number of users who have signed up to participate in the corresponding system 100. In some embodiments, different databases or different groups of potential target handlers 155 may be available based on details associated with the task, such as the potential for confidentiality requirements.

The method may then select (450) the offsite target handler 155 based on the corresponding compatibility score prior to transmitting the request (at 510). If the most compatible target handler 155 declines the request, the method may proceed to select the following target handler 155 based on the ranking of compatibility scores (at 440).

In many embodiments, the user interface 190 is a video game console, as discussed above. As such, the potential target handlers 155 in the database may be gamers, or people having video game experience. The compatibility score may then be at least partially based on a measure of video game experience associated with the corresponding potential target handler 155. For example, such a measure of video game experience may be a ranking in the context of a particular video game console, a specific video game, a defined video game league, or an esports league. In such an embodiment, the ranking may be assumed to reflect a level of skill or an amount of time interacting with the corresponding video game console, specific video game, defined video game league, or esports league.

Generally, if the remote control interface is provided at a video game console 190, the measure of video game experience is associated with that video game console, and the remote control interface is provided at the corresponding video game console.

In some embodiments, the compatibility score may be at least partially based on a variety of factors. Such factors may include proximity to a physical location of the robotic unit 110 to be operated. Such a factor may render a particular potential target handler 155 more likely to successfully complete the portion of the task 120 because physical proximity may reduce latency, or lag, due to the communication network 150, and may thereby increase the likelihood of success for any given skill level.

Similarly, a user's internet connection quality at their internet access connection 200 may be considered when determining how they should be ranked as a potential target handler 155.

Other factors may include the potential target handler's 155 employment status or employment history, as such status or history may indicate familiarity with the particular task the robotic unit 110 is attempting to complete. For example, if the potential target handler 155 is a welder or has previously been employed as a welder, he may be more likely to successfully complete portions of corresponding tasks 120.

Similarly, the compatibility score may be partially based on a potential target handler's previous experience with robotics. In some embodiments, referrals may be considered as well. For example, if a user has been utilized as a target handler 155 by the system 100 for previous tasks, then they may be recommended by a particular supervisor, or the system itself may generate a ranking which may function as a positive referral. Accordingly, prior participation history in control of the robotic unit 110 or other such units in the system 100 may be considered.

Also considered may be complexity of the portion of the task 120, as well as category of task associated with the portion. Accordingly, the portion of the task 120 may be assigned a complexity rank based on an assessed difficulty of the portion. The compatibility score may then be more heavily weighted towards an assessed skill level of the potential target handler for a portion having a higher assessed difficulty than for a portion having a lower assessed difficulty.

In some embodiments, where the portion is identified for manual execution or supervision due to insufficient training data for autonomous operation, the assessed difficulty may be based at least partially on an amount of training data available for the portion. Similarly, where a portion has no available training data, it may be assessed as having a higher difficulty than a portion having insufficient available training data.

The portion of the task 120 may be further classified based on a category of task of which it is a portion. The compatibility score may then be weighed more heavily towards a prior participation history in control of the robotic unit 110 or employment history related to robotic control specifically in the category of task.

The training method disclosed herein may be utilized to implement robotic systems 100 more quickly than would otherwise be possible. Traditionally, system integrators could not implement systems until they could consistently perform all required tasks to a reasonable degree. The training method disclosed herein would allow systems 100 to be implemented and launched without as complete of a training database, recognizing that data will continue to be supplemented by way of manual execution or supervision of less frequent tasks.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

Further, in some embodiments of the present invention, some or all of the method components are implemented as a computer executable code. Such a computer executable code contains a plurality of computer instructions that when performed in a predefined order result with the execution of the tasks disclosed herein. Such computer executable code may be available as source code or in object code, and may be further comprised as part of, for example, a portable memory device or downloaded from the Internet, or embodied on a program storage unit or computer readable medium. The principles of the present invention may be implemented as a combination of hardware and software and because some of the constituent system components and methods depicted in the accompanying drawings may be implemented in software, the actual connections between the system components or the process function blocks may differ depending upon the manner in which the present invention is programmed.

The computer executable code may be uploaded to, and executed by, a machine comprising any suitable architecture. Preferably, the machine is implemented on a computer platform having hardware such as one or more central processing units (“CPU”), a random access memory (“RAM”), and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

The functions of the various elements shown in the figures may be provided through the use of dedicated hardware as well as hardware capable of executing appropriate software. When provided by a processor, the functions may be provided by a single dedicated processor, by a single shared processor, or by a plurality of individual processors, some of which may be shared. Explicit use of the term “processor” or “controller” should not be construed to refer exclusively to hardware capable of executing software, and may implicitly include, without limitation, digital signal processor hardware, processing circuitry, ROM, RAM, and non-volatile storage.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A method for controlling a robotic unit comprising:
operating the robotic unit to autonomously perform at least one task;
identifying a portion of the at least one task to be manually executed or supervised;
selecting an offsite target handler for manually executing or supervising the portion of the at least one task;
transmitting a request to the target handler selected;
upon receiving an indication of acceptance of the request from the target handler, providing the target handler with a remote control interface by which the portion of the task may be manually executed or supervised;
receiving, at the remote control interface, control inputs for the robotic unit;
providing, at the remote control interface, an information feed including real time status information for the robotic unit;
confirming that the portion of the at least one task has been completed; and
terminating the remote control interface.

2. The method of claim 1, wherein the identification of the portion of the at least one task to be manually executed or supervised comprises identifying a failure of the robotic unit to autonomously complete a task, and wherein the portion is to be manually executed.

3. The method of claim 1, wherein the identification of the portion of the at least one task to be manually executed or supervised comprises identifying a task not previously executed by the robotic unit.

4. The method of claim 1, wherein the autonomous operation of the robotic unit is by way of a learning algorithm, and wherein the identification of the portion of the at least one task to be manually executed or supervised comprises identifying a task for which the robotic unit has insufficient training data, and wherein a portion of the at least one task is to be supervised by the target handler, and wherein the target handler may choose to intervene by way of the remote control interface, thereby overriding an autonomous attempt by the robotic unit.

5. The method of claim 4, wherein upon intervention by the target handler, control inputs received by way of the remote control interface are recorded and incorporated into the training data.

6. The method of claim 1, wherein the autonomous operation of the robotic unit is by way of a learning algorithm, and wherein the identification of the portion of the at least one task to be manually executed or supervised comprises identifying a task for which the robotic unit has insufficient training data, wherein the learning algorithm is a convolutional neural network (CNN) and wherein the CNN is trained using prior iterations of the portion of the at least one task, and wherein upon confirming that the portion has been completed, control inputs received by way of the remote control interface are incorporated into the training data.

7. The method of claim 1, wherein selecting the offsite target handler comprises:
retrieving, from a database, a list of potential target handlers available for executing the portion of the at least one task;
for each of the potential target handlers, computing a compatibility score for ranking the likelihood that the potential target handler would complete the portion of the task if selected;
selecting the offsite target handler based on the corresponding compatibility score,
wherein the potential target handlers are people having video game experience, and wherein the compatibility score is at least partially based on a measure of video game experience associated with the corresponding potential target handler, wherein the measure of video game experience is a ranking in the context of a video game console, a specific video game, a defined video game league, or an esports league, the ranking reflecting a level of skill or an amount of time interacting with the video game console, specific video game, defined video game league, or esports league.

8. The method of claim 7 wherein the compatibility score is at least partially further based on at least one of:
proximity to a physical location of the robotic unit to be operated;
employment status;
employment history;
experience with robotics;
referrals;
internet connection quality of the corresponding potential target handler; and
prior participation history in control of the robotic unit.

9. The method of claim 7 wherein the measure of video game experience is associated with a video game console, and wherein the remote control interface is provided at the corresponding video game console.

10. The method of claim 9 wherein transmitting the request to the target handler is by way of a personal electronic device different than the video game console utilizing push notifications.

11. The method of claim 1 wherein the remote control interface is provided by way of a video game console, and wherein the control inputs are received at the video game console by way of video game controllers.

12. A method for training a robotic unit comprising:
identifying a portion of at least one task to be manually executed;
transmitting a request to a target handler for manually executing the portion, the target handler having a remote control interface by which the task may be manually executed;
receiving, at the remote control interface, control inputs for the robotic unit;
providing, at the remote control interface, an information feed including real time status information for the robotic unit;
recording, in a database, the control inputs received at the remote control interface;
confirming that the portion of the at least one task has been completed; and
utilizing the control inputs recorded in the database for training a learning algorithm for autonomously controlling the robotic unit.

13. The method of claim 12 further comprising recording the information feed in the database, and wherein the information feed is utilized with the control inputs recorded for training the learning algorithm.

14. The method of claim 12 wherein the robotic unit operates autonomously to perform the at least one task, and wherein the identifying of a portion of the at least one task is by evaluating a plurality of portions of the at least one task and determining that the robotic unit has attempted and failed to complete the portion identified.

15. The method of claim 14 wherein the autonomous operation of the robotic unit is based on the learning algorithm being previously trained to complete portions of the at least one task, and wherein the identification of the portion is by determining that the robotic unit has been provided with insufficient training data for the portion.

16. The method of claim 15 wherein the learning algorithm is a convolutional neural network (CNN) and wherein the training data is derived from previous iterations of implementations of the at least one task.

17. The method of claim 16 wherein the database is a database of training data for the CNN, and upon confirming that the portion of the at least one task has been completed, the CNN is further trained to execute the portion of the at least one task based on the control inputs recorded.

18. The method of claim 12 wherein the target handler is offsite from the location of the robotic unit and is selected upon identifying the portion of the at least one task to be manually executed, and wherein the transmitting of the request is to the selected target handler,
wherein selecting the target handler is by retrieving, from a database, a list of potential target handlers available for executing the portion of the at least one task, computing a compatibility score for ranking the likelihood that each of the potential target handlers would complete the portion of the task if selected, and selecting the target handler based on the corresponding compatibility score,
wherein the potential handlers are people having video game experience, and
wherein the compatibility score is at least partially based on a measure of video game experience associated with the corresponding potential target handler.

19. The method of claim 18 wherein the remote control interface is provided by way of a video game console, and wherein the control inputs are received at the video game console by way of video game controllers.

20. A robotic system comprising:
a robotic unit having a manipulation tool configured to execute at least one task;
a memory containing instructions for operating the robotic unit to execute the at least one task;
processing circuitry for operating the manipulation tool based on the instructions; and
a communications interface by which the robotic unit can be controlled remotely;
wherein the instructions in the memory include training data for a learning algorithm, and wherein the instructions cause the robotic unit to:
operate autonomously to perform portions of the at least one task based on an output of the learning algorithm;
identify a portion of the at least one task for which the training data is insufficient;
select an offsite target handler for manually executing the portion of the at least one task;
transmit, by way of the communications interface, a request to the target handler selected;
upon receiving an indication of acceptance of the request from the target handler, provide the target handler with a remote control interface by which the task may be manually executed;
receive, at the remote control interface by way of the communications interface, control inputs for the robotic unit;
record, at the memory, the control inputs received; and
incorporate the control inputs received into the training data.
